(19) United States
(12) Patent Application Publication
(10) Pub. No.: US 2003/0083206 A1
(43) Pub. Date: May 1, 2003

(54) Oil and gas production optimization using dynamic surface tension reducers

(75) Inventors: James Darrell Masikewich, Calgary (CA); Shaun Terrance Einar Mesher, Calgary (CA)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Newpark Canada Inc., Calgary (CA)

(21) Appl. No.: 10/214,664

(22) Filed: Aug. 8, 2002

(30) Foreign Application Priority Data
Aug. 8, 2001 (CA) 2,354,906

(51) Int. Cl. C09K 7/00

(52) U.S. Cl. 507/265

(57) ABSTRACT

The addition of dynamic surface tension reducers to drilling fluids or work over and completion fluids results in improved fluid system performance and improved oil and gas production values.

### FIELD OF THE INVENTION

This invention relates to the field of oil and gas production, and more specifically to the improvement of the properties and/or performance of both fluids and fluid system additives used in the drilling of oil and gas wells and in the post-drilling treatment of oil and gas wells using dynamic surface tension reducing surfactants.

### BACKGROUND OF THE INVENTION

When drilling and servicing, oil or gas wells, the wellbore and in some cases the surrounding rock is normally exposed to either fabricated or produced (natural) fluids. The fabricated fluids are usually referred to as either “drilling fluids” or “work over and completion fluids”. Fluids that are used to facilitate the “enhanced production” of an oil or gas well or oil field are called “stimulation fluids” or sometimes “enhanced oil recovery (EOR) fluids”.

While drilling, it is the normal practice to circulate a drilling fluid, usually referred to as a drilling mud, down the drill string, through the drill bit and then back up to the surface through the annulus between the drill string and the borehole wall. Drilling mud is formulated with water and/or oil as a base fluid, which typically contains a mixture of commercial additives or chemical products such as viscosifying polymers and/or clays to provide Theological properties to the mud. Other chemicals impart various properties such as; reduced fluid loss, clay stability, alkalinity and density. These chemicals are most often mixed at the well site.

Drilling fluids perform a variety of functions and their characteristics, and chemical composition are carefully designed and monitored depending upon the functions to be performed. Principal functions of drilling fluids include; transport of drilled cuttings to the surface, control of sub-surface formation fluid pressures, stabilizing the wellbore, minimizing the invasion of the filtrate or liquid phase of the drilling fluid into the rock being drilled, and to protect the crude oil and natural gas hydrocarbon bearing formation rock from being damaged.

As drilling progresses, steel casing is lowered into the borehole and cemented into place. Several progressively smaller strings of casing may be used, depending on the complexity of the well. If casing is not placed by the hydrocarbon bearing production zone, the well is referred to as an “open hole completed” well. If casing is adjacent to the hydrocarbon-producing zone, the well is referred to as a “cased hole completion”.

Completion, workover, and stimulation fluids are used after a well has been drilled. These fluids may be formed with water and/or oil and complementary chemicals. Functions of completion and workover fluids include; corrosion inhibition, minimization of fluid losses into the production zone, and control of sub surface formation pressures while the drilling or service rig is performing mechanical functions such as perforating casing or pump replacement. Functions of stimulation fluids often entail; “washes” or “squeezes” with solvents or acids to remove waxy build-ups, scale, or clays. Fracturing fluids are used to break the production zone rock to promote increased conductivity of hydrocarbons towards the wellbore.

Enhanced Oil Recovery usually refers to a process where liquids or gasses are injected into a depleted production zone to push the remaining hydrocarbon towards the producing wells in the field.

Fluid design for any oil or gas well application considers several criteria including the impact that the fluid may have on the rock being drilled, the cost effectiveness of commercial additives as well as any impact the fluid may have on Health, Safety and Environment (HSE).

Drilling most often commences through non-productive rock into the hydrocarbon-bearing zone, called the production zone. The non-productive rock usually consists of shales and/or mudstone but may be carbonate or sandstone as well. The objective during this stage in drilling is usually to maximize the rate of penetration realized by the bit and to ensure the well path remains on target. Here the issues are often associated with the stability of the borehole over time and the drilling fluid system is designed to address these issues. When the production zone is penetrated, the objective is to protect it from invasive damage to its permeability and productivity caused by the drilling fluid or by the mechanical process of drilling through it. The industry has documented several formation damage mechanisms, including those discussed in Society of Petroleum Engineers (SPE) Papers No. SPE 60325, 59753 and 35577. These include clay swelling, clay migration, in-situ fines migration, scaling and precipitates, waxing, grinding and mashing of drilled cuttings, glazing, emulsion blocking and water blocking.

Water blocking commonly occurs in desiccated gas reservoirs. In a gas reservoir that contains excess water, as the gas moves toward the wellbore, it will push the water along with it. At some point, the available reservoir pressure will be insufficient to overcome the capillary pressure holding the remaining water in the rock. At this point, the percentage of water in the rock—called the water saturation, is deemed irreducible. In some instances, geological phenomena such as heat and pressure cause the rock to lose most of its water. Where this is the case, it is possible to have a sub-irreducibly saturated reservoir. In a sub-irreducibly saturated reservoir, the permeability to gas is improved, as there is less water to hamper the flow of the gas. When the reservoir is contacted by a drilling fluid, the water component (filtrate) of the drilling fluid can be imbibed into reservoir rock to satisfy the capillary phenomena present. This imbibition will continue until the rock reaches it's irreducible saturation state. As more water is imbibed, the permeability and thus the productivity of the rock is reduced. The problem is known as water blocking or phase trapping. Surface tension reduction and desiccation with workover and completion fluids are well known mitigation methodologies. The problem is that most applications involve the addition of alcohols, to workover and completion fluids, as taught in U.S. Pat. No. 5,877,126. This practice can pose a significant HSE problem especially with regard to drilling fluids—where a continuous circulating system is employed and alcohol treatments made at the surface are pumped down the well and re-circulated back to surface. In these instances, the drilling fluid may become volatile, having a low flash point and the fumes from the drilling fluid system may be potentially harmful to personnel.

When mixing commercial additives into water or base oil, wetting equipment—usually a hopper—and dispersing (shearing) equipment—usually mechanical agitators or fluid “jets”—are used. This equipment can increase the cost effectiveness of the product by enhancing the rate of dispersion and in the case of water-soluble additives, the subsequent hydration of the commercial additive. Often special shearing devices are used to assist to this end. The dispersion of commercial additives, for example as taught in U.S. Pat. Nos. 6,413,914 and 5,401,313, would be more efficient if there was a reduction in the surface tension of the base fluid. This is particularly applicable when fluids are chilled to avoid erosion of permafrost in Arctic drilling.

Any fluid design process must consider the eventual disposal of the fluid and entrained solids and any associated environmental impact. Therefore, the ability to treat the fluid and/or solids if required to comply with environmental criteria is important. In the case of oil-based fluids, the drilled rock cuttings will be coated in oil based drilling fluid. If the volume of this fluid is excessive, there will be an associated cost to treat the cuttings to separate them from the fluid prior to disposal. It has been discovered that dynamic surface tension reducers can reduce the volume of oil associated with the cuttings to facilitate compliant disposal of the cuttings and recovery and recycling of the fluid component.

In a similar application, wells that are drilled through heavy oil sands often exhibit a problem unique to that type of formation. The sandstone drilled cuttings returning to surface with the drilling fluid are coated with a sticky bitumus film. The sticky nature of the rock results in gummed up equipment on surface as well as problems with down hole equipment. It has been discovered that dynamic surface tension reducers can be powerful enough to strip bitumen off the sand—reducing the problem.

Subsequent to drilling, hydraulic fracturing has been widely used for stimulating the production of crude oil and natural gas from wells completed in depleted reservoirs or reservoirs of low permeability. Methods employed normally require the injection of an often polymer-viscosified fracturing fluid containing suspended propping agents into a well at a rate sufficient to open a fracture in the exposed formation. Continued pumping of fluid into the well at a high rate extends the fracture and leads to the build up of a bed of propping agent particles between the fracture walls. These particles prevent complete closure of the fracture as the fracturing fluid is subsequently recovered to the surface or leaks off into the adjacent formations and results in a permeable channel extending from the well bore into the formation.

Fracturing of low permeability reservoirs has always presented the problem of fluid compatibility with the formation core and formation fluids, particularly in gas wells. Another problem encountered in fracturing operations is the difficulty of total recovery of the fracturing fluid. Fluids left in the reservoir rock as immobile residual fluids impede the flow of reservoir gas or fluids to the extent that the benefit of fracturing is decreased or eliminated. The removal of the fracturing fluid may require the expenditure of a large amount of energy and time, consequently the reduction or elimination of the problem of fluid recovery and residue removal is highly desirable.

Another role for stimulation fluids is to remediate formation damage which occurs as a result of oil passing through the formation into the near wellbore area and undergoing a severe pressure and temperature change. These changes result in physical changes to the oil and some compounds such as salts or waxes held in solution (in the formation) precipitate out in the near wellbore area and cause production problems.

Stimulation fluids can also enhance oil recovery. In this case, water, steam or CO₂ are injected into the formation at a distance from the producing well. The injected liquid increases the pressure in the formation and creates a driving force to push additional oil out of the formation. A reduction in the interfacial tension between the rock of the near wellbore area (injector or producer) and the producing fluids could alleviate some of these problems.

More recently, the problems discussed above have been sought to be overcome by reducing the friction between the fluids and solids introduced into the well during drilling or subsequent treatment and the formation fluids and solids. This has entailed the use of surfactants to reduce surface tension between, for example, liquid/liquid and liquid/solid interfaces. These surfactants are herein termed equilibrium surfactants because they are effective under conditions where the surfactant is allowed to reach a state of equilibrium. Equilibrium surfactants are however relatively slow acting with respect to the speed with which the surfactants migrate to the interfaces. As a result, in the dynamic environment of drilling, completion operations and work over and stimulation, due to their large molecular size and/or ionic charge, equilibrium surfactants simply act too slowly or are too volatile to be completely effective. It has been discovered that additional benefit can be realized if “dynamic” surfactants are used to promote greater efficiency in dynamic drilling or completion applications and other fast moving operations such as cementing, improved flow over shaker screens or preventing bit balling. What is required is a more dynamic system.

### SUMMARY OF THE INVENTION

The present invention relates to improved fabricated drilling and servicing fluids and slurries whereby a dynamic surface tension reducer (“DSTR”) is added to the fluid system.

DSTRs are non-ionic acetylenic glycols that have been ethoxylated to varying degrees and are more specifically described in U.S. Pat. Nos. 4,117,249, 5,560,543 and 6,313,182, the teachings of which are hereby incorporated by reference. Suitable DSTRs are available from, for example, Air Products and Chemical Inc. of Allentown, Pa.

DSTRs are surfactants that diffuse rapidly to liquid and/or solid interfaces. They can therefore reduce surface tension even under dynamic conditions. DSTRs are therefore far more effective than equilibrium surfactants at reducing surface tension in the dynamic environment of drilling and treatment operations.

When DSTRs are used in drilling muds, the decrease in mud surface tension contributes to improved production values and improved drilling operations; generally, higher levels of DSTR correlate with enhanced production. More specifically, the reduction of surface tension using DSTRs may provide the following advantages in fabricated fluids:

Minimization of formation damage, characterized by aqueous phase trapping;

Enhanced performance and yield (dispersion and hydration) of viscosifying polymers use in water-based systems;

Enhanced performance and yield of viscosifying polymers in low-temperature conditions;

Enhanced dispersion of clay materials in oil-based systems;

Reduction of oil on drilled solids;

Improved flow over shaker screens for improved separation of cleaner cuttings;

Reduction of interfacial surface tension in fracturing fluids;

Enhanced production in a fractured well where DSTR is coated on proppant; and

Enhanced hydrocarbon flow in producing wells and water injectors

DSTR surfactant molecules are preferably used at concentrations of between 0.05% to 0.5% by weight (although concentrations of up to 10% are possible), and further testing and experience may indicate that concentrations outside the range of 0.05% to 10% are useful. For example, the addition of 0.05-0.5% DSTR will lower a water-based mud's surface tension from 72 dynes/cm to approximately 26-40 dynes/cm. The addition of 500 ppm of the DSTR Dynol™ 604 to a light mineral oil will take the surface tension of the oil from 30 dynes/cm to 0.75 dynes/cm. DSTRs have the effect of reducing air entrapment, foaming tendencies, and friction between different interfaces. They also reduce water phase trapping in low permeability gas reservoirs by reducing the interfacial tension between the oil and water layers. At concentrations of 0.05-0.5% by weight, DSTRs improve hydration of clays and polymers, as well as wetting of weighted materials. DSTRs improve the ability of the drilling mud to inhibit native shale, and to remove drilled solids; DSTRs also increase the permeability of the formation in the near-wellbore area.

When a liquid, such as water, and a solid, such as a polymer, are mixed together, two forces are acting upon the system. Adhesion is the attractive force between the water and the polymer, and cohesion is the attractive force between water molecules. When adhesive forces are greater than cohesive forces, the liquid will wet, or spread over, the solid. When cohesive forces are greater than adhesive forces, the solids will clump together and not “wet” efficiently. Reducing the surface tension of a liquid increases the adhesive forces and decreases the cohesive forces at the interface, promoting wetting of the solid.

Where a DSTR is added to a water-based drilling mud, the cohesive forces of the water decrease to the point where they are weaker than the adhesive forces between the water and polymer, and the polymer becomes wet. The rate at which the polymer becomes wet is dependent on the rate of DSTR diffusion and the concentration of DSTR. Accordingly, because DSTR's diffuse quickly, they are effective at promoting wetting of polymer in a water-based drilling mud. This can improve the polymer's yield to produce more viscosity from less polymer. The same should be true with respect to the hydration of polymers used in fracturing fluids.

Similarly, where DSTR is coated on polymer, it promotes wetting of the polymer by an oil-based drilling mud. The presence of DSTR results in increased adhesive forces between polymer and oil, such that wetting of the polymer is almost instantaneous.

Moreover, DSTRs enhance the properties of the other mud chemicals, and quicken the rate at which these chemicals work to develop properties consistent with a drilling mud at concentrations as low as 0.05% DSTR by weight. The addition of a small percentage of a DSTR to the liquid phase of a drilling mud results in an increased dispersability of the drilling mud chemicals in water-based systems.

When a solid material is added to a liquid to enhance the properties or performance characteristics of the liquid, the solid material must disperse within the liquid to be effective. In the context of drilling muds, a common problem is fish eying or clumping, where a dry chemical added to the drilling mud clumps and is therefore less effective. In water-based drilling muds, clumping can occur due to the fact that the liquid has a much greater surface tension than the solid. When the solid is placed into the liquid, the solid particles are more attracted to each other than to the liquid molecules, since the surface tension of the water surrounding the particle is so strong. Therefore, by reducing the surface tension of the water, thereby increasing the likelihood of solid-liquid molecule attraction, clumping may be reduced or even eliminated so that equivalent or better yields can be obtained from smaller amounts of chemical.

A further advantage of DSTRs is the increased dispersion of clay materials in oils and oil-based drilling muds with the addition of DSTR. Where the clay particles are more dispersed, the concentration of clay particles is more constant, resulting in increased viscosity and better performance of the drilling mud. One possible explanation for this effect is that clay particles are attracted to polar molecules. When DSTR is added, it reduces the surface tension on the clay surface, allowing the oil to spread over the clay surface and disperse the clay particles. This can also permit the use of smaller amounts of clay to obtain the same or better performance comparable to muds prepared without DSTR's.

In the past, clay particle dispersion has not been a problem, because diesel was the oil most commonly used. Diesel disperses clay particles quite readily, due to its high aromatic hydrocarbon content. However, stricter health and environmental regulations now mean that diesel is being replaced by safer and less aromatic fluids that are less efficient at dispersing clay particles.

DSTRs may also be linked to the surface of proppants such as silica or ceramic particles. Once the proppant surface becomes water wet (or oil wet), the proppant expels small amounts of DSTR into the surrounding matrix to reduce interfacial surface tension within the proppant pack, increasing the conductivity of the fractures. For example, Surfynol™-104 (solid) may be dissolved in a solvent such as acetone at 1-10% by weight, and placed in contact with a porous proppant such as a ceramic proppant Norton™ 20/40 lightweight proppant, available from Norton Proppants, Fort Smith, Ariz. The surfactant is absorbed into the porous surface and the solvent evaporated to leave the DSTR on the proppant. The treated proppant may be added to untreated proppant at various ratios between 1 and 100% (treated to untreated proppant).

DSTRs at a concentration of 500 ppm or in a range between 0.05% and 5% by weight added to fracturing fluids could reduce the interfacial tension and/or surrounding formations within the proppant pack, and allow the spent fluid to more easily flow back out of the proppant pack to the surface.

The addition of DSTR to solvent during solvent squeezes also improves production. Solvent squeezes are carried out periodically during oil drilling. With the addition of DSTR (1-5 L/m³) to an oil-based solvent, DSTR is transferred into water-wet pores in the formation rock, thus reducing water surface tension and increasing oil flow and production.

Water injection wells benefit by the reduction of interfacial tensions. The addition of 200 ppm DSTR to the water injector decreases injection pressures and increases the volume of water added to the well.

According to an aspect of the present invention, there is provided a fabricated fluid for use in the drilling, completion, work over or servicing of oil and gas wells or as used in the treatment or for the enhancement of production from oil and gas bearing formations, wherein said fabricated fluid includes therein a dynamic surface tension reducing (DSTR) surfactant present in a predetermined amount.

According to a further aspect of the present invention, there is also provided a fabricated fluid for use in the drilling, completion, work over or servicing of oil and gas wells or as used in the treatment or for the enhancement of production from oil and gas bearing formations, the improvement wherein a dynamic surface tension reducing (DSTR) surfactant is added to said fabricated fluid in a predetermined amount, said DSTR being ethyoxylated non-ionic acetylenic glycol present at a concentration of between 0.05% and 10% by weight.

According to yet a further aspect of the present invention, there is also provided proppant particles for use in the fracturing of oil and gas bearing formations penetrated by a well bore, the improvement wherein dynamic surface tension reducing (DSTR) surfactant is linked to a surface of some or all of said proppant particles.

According to yet another aspect of the present invention, there is also provided in a method for the separation of cuttings produced during the drilling of a well bore from fluids used to transport said cuttings from the bottom of said well bore to the surface, the improvement wherein said fluid is treated by the addition of a predetermined amount of dynamic surface tensioning reducing (DSTR) surfactant to reduce adhesion between said cuttings and said fluid to facilitate the separation therebetween.

According to yet another aspect of the present invention, there is also provided a method of admixing a fabricated fluid, for use in the drilling, completion, work over or surfacing of an oil or gas well or as used in the treatment or for the enhancement of production from an oil or gas bearing formation, together with at least one chemical additive, comprising the steps of adding said at least one chemical additive to said fabricated fluid; adding a predetermined amount of a dynamic surface tension reducing (DSTR) surfactant to said fabricated fluid; and admixing said fabricated fluid, said at least one chemical additive and said DSTR to prepare said fabricated fluid for use.

According to yet another aspect of the present invention, there is also provided a method of fracturing an underground hydrocarbon bearing formation penetrated by a well bore, comprising the steps of injecting a stream of fluid into said formation at a pressure selected to cause the formating of at least one fracture in said formation; introducing proppants into said stream of fluid for injection of said proppants into said at least one fracture; and combining at least some of said proppants with dynamic surface tension reducing (DSTR) surfactant prior to injecting said proppants into said formation, whereby said DSTR surfactant is available to reduce surface tension between said proppants and fluids in contact with said proppants in said fracture.

According to yet another aspect of the present invention, there is also provided a method of propping open a hydraulically fractured underground oil or gas bearing formation penetrated by a well bore, comprising the steps of introducing proppant particles into a stream of pressurized fracturing fluid, some or all of said proppant particles having dynamic surface tension reducing (DSTR) surfactant contacted to a surface thereof; and pumping the mixture of said fracturing fluid and said proppant particles down said well bore into said formation to deposit said proppant particles in said hydraulically fractured underground formation.

### DETAILED DESCRIPTION OF THE PREFERRED EMBODIMENTS

The invention is now further described with particular reference to the following non-limiting examples, which illustrate the capabilities of dynamic surface tension reducing surfactants in the application of fabricated fluids to oil and gas production optimization.

Synthesis and analysis of drilling muds were carried out at Newpark Canada, Calgary, Alberta. Surface tension measurements were mainly performed at Air Product and Chemicals Inc., Allentown, Pa., and regain permeability testing was done at Hycal Energy Research Laboratories Inc., Calgary, Alberta.

Examples 1-4 show how a drilling mud's properties are enhanced to minimize formation damage while drilling in low permeability gas reservoirs. Various surfactants were tested to determine the following:

1) The surface tension reduction in a water-based mud system;

2) How the surfactants affect the rheology of the mud system;

3) The concentration required to minimize formation damage; and

4) The concentration required to stimulate production from the formation being drilled

Regain permeability testing was done to determine the degree of damage mitigation and/or production enhancement.

### EXAMPLE 1

A water-based mud system was made by mixing the following ingredients at the given concentrations:

Calcium carbonate (micro) at 15 kg/m³, calcium carbonate (325) at 15 kg/m³, HEC-10 at 3 kg/m³, XCD polymer at 1 kg/m³, sodium hydroxide (pH 10) at 0.2 kg/m³ and T352 (gluteraldehyde) at 0.5 kg/m³.

Various surfactants were also added, at varying concentrations. The concentration of surfactant was determined by its cost, such that the cost of the surfactant in a cubic meter of drilling mud would be CDN$60.

Sample B, n-butanol, was tested because it is known to be effective in reducing drilling mud surface tension and thereby reducing formation damage, as disclosed in U.S. Pat. No. 5,877,126 to Masikewich et al. However, n-butanol is not a suitable surfactant as it is a severe fire and health hazard.

The materials were added to 1.0L of water and mixed at medium speed for 15 minutes at room temperature.

A surface tension apparatus supplied by the Q Glass Company, Towaco, N.J., was used to measure the surface tension of each sample.

Table I illustrates the effect of surfactant on the rheology of drilling mud. In samples C through H, the addition of DSTR surfactant reduced the surface tension of the mud without affecting the rheology of the mud system. Sample F demonstrated extreme amounts of foaming.

TABLE I

| Sample | | A | B | C | D | E | F | G | H | I | J |
|---|---|---|---|---|---|---|---|---|---|---|---|
| | | Blank | n-butanol | Superwet ™ | Dynol ™ | Surfynol ™ | Surfynol ™ | Surfynol ™ | CT-111 | DMPS | Butyramide |
| | | | | | 604 | 420 | PSA336 | 104 | | | |
| DSTR | $60/m³ | | 2.8 | 0.5 | 0.102 | 0.307 | 0.305 | 0.19 | 0.35 | 0.16 | 0.104 |
| wt/v % | | | | | | | | | | | |
| (6 spd) | 600(RPM) | 77 | 77 | 73 | 71 | 69 | 73 | 68.5 | 74 | 78 | 91 |
| | 300(RPM) | 57 | 59 | 55 | 53 | 51 | 55 | 51 | 56 | 59 | 68 |
| | 200(RPM) | 48 | 48.5 | 46 | 44 | 42.5 | 46.5 | 42.5 | 47 | 49 | 55 |
| | 100(RPM) | 36 | 36 | 34 | 32 | 31 | 34.5 | 31 | 34 | 37 | 41 |
| | 6(RPM) | 10 | 9.5 | 9 | 7 | 7 | 9 | 7 | 9 | 10 | 12 |
| | 3(RPM) | 7 | 6.5 | 6 | 4.5 | 4.5 | 6 | 4.5 | 6 | 7 | 9 |
| | Initial Gel | 3.5 | 3.5 | 3.5 | 2.5 | 2.5 | 3.5 | 2.5 | 3 | 3.5 | 4 |
| | 10 m gel | 4 | 4 | 4 | 3 | 3 | 4 | 3 | 3.5 | 4 | 4.5 |
| | PV | 20 | 18 | 18 | 18 | 18 | 18 | 17.5 | 18 | 19 | 23 |
| | YP | 18.5 | 20.5 | 18.5 | 17.5 | 16.5 | 18.5 | 16.7 | 19 | 20 | 22.5 |
| | API Fluid loss | 6.4 | 8.2 | 7.6 | 7.2 | 6.8 | 6.8 | 2.6 | 5.4 | 8.2 | 7.2 |
| | Filtrate Surface | 65 | 41 | 34 | 32 | 31 | 26 | 34 | 30.50 | 64 | 64 |
| | tension | | | | | | | | | | |

### EXAMPLE 2

A water-based system was made as set out in Example 1. Surfactants from samples C,D,E,G and H were added at concentrations lower than in Example 1, in order to determine the ideal concentration of surfactant. Mud surface tension was again measured.

Table II illustrates that samples D,E and G still had reduced surface tension, even when lower concentrations of surfactant were added.

TABLE II

| | | Surface tension of mud |
|---|---|---|
| Sample | Wt/V % | (Dynes/cm) |
| C | 0.17 | 42 |
| D | 0.033 | 30 |
| E | 0.1 | 31 |
| G | 0.06 | 32 |
| H | 0.117 | 38 |

### EXAMPLE 3

A water-based system was made as set out in Example 1. Surfactants from samples D,E,G and H were added at concentrations lower than in Example 2. Mud surface tension was again measured.

Table III illustrates that samples D,E,G and H no longer had reduced surface tension at these surfactant concentrations.

TABLE III

| | | Surface tension of mud |
|---|---|---|
| Sample | Wt/V % | (Dynes/cm) |
| D | 0.017 | 40 |
| E | 0.05 | 38 |
| G | 0.03 | 41 |
| H | 0.058 | 42 |

### EXAMPLE 4

The surfactants from samples D,E and G were then dissolved in distilled water and tested on a limestone (Texas Cream) core to determine overall regain permeability.

Table IV illustrates the percentage of regain permeability for each sample.

TABLE IV

| Sample | Regain Permeability % |
|---|---|
| Blank | 95% |
| Sample D (430 ppm) | 80% |
| Sample E (1285 ppm) | 101% |
| Sample G (792 ppm) | 90% |

Examples 5 and 6 show that the surfactants improve the rheological properties of a water-based mud, and, in particular, enhance the chemical ingredients of the drilling mud.

### EXAMPLE 5

A water-based mud was prepared by mixing together the following ingredients at the given concentrations:

KCl brine solution at 90,000 chlorides; Newxan™ at 4.5 kg/m³. In sample K, 3 L/m³ of the surfactant CT-111 was also added.

The mud was mixed together at low speed to minimize temperature buildup, at a temperature of −4° C. Rheology of the mud was measured over a period of six hours.

Table V illustrates the rheology of sample K and a blank. Sample K after six hours illustrates improved mixing and rheological properties.

TABLE V

| | VISCOMETER RPM | | | | | | | |
|---|---|---|---|---|---|---|---|---|
| | 600 | 300 | 200 | 100 | 6 | 3 | PV* | YP* |
| Blank 0.5 hr | 7 | 3.5 | 2 | 1 | 0 | 0 | 3.5 | 0 |
| Blank 3 hr | 12 | 6.5 | 4 | 2 | 1 | .5 | 5.5 | .5 |
| Blank 6 hr | 12.5 | 6.5 | 4.5 | 2.5 | .5 | .5 | 6 | 2.5 |
| K-0.5 hr | 15 | 8 | 5 | 3 | 1 | 1 | 7 | .5 |
| K-3 hr | 25 | 15 | 11 | 7 | 1.5 | 1 | 10 | 2.5 |
| K-6 hr | 36 | 22 | 16.5 | 10.5 | 2.5 | 2 | 14 | 4 |

*Plastic Viscosity
*Yield Point

### EXAMPLE 6

A water-based mud was prepared by mixing together the following ingredients at the given concentrations:

Drispac™ R at 1.5 kg/m³, Staflo™ E/L at 3.5 kg/m³, NewXan™ at 0.25 kg/m³, FL-2 at 10 kg/m³, sodium hydroxide at 0.2 kg/m³, OSR-30 at 10 kg/m³ and 15% bitumus sandstone core at 200 kg/m³. In sample L, the surfactant CT-111 was also added at a concentration of 3 L/m³.

The materials were added to 1.0 L of water and mixed for 30 minutes at high speed.

The rheology of each sample was measured. The samples were then placed in a hot roll cell and rolled for 20 hours at room temperature. The samples were removed and the rheology measured again.

Table VI illustrates the rheology measurements before and after hot rolling. The results show that the surfactant improves the properties of the drilling mud faster than conventional systems.

TABLE VI

| | VISCOMETER RPM | | | | | |
|---|---|---|---|---|---|---|
| | 600 | 300 | 200 | 100 | 6 | 3 |
| Blank | 60 | 41 | 34 | 22 | 3 | 2 |
| Blank after HR | 70 | 49 | 40 | 27 | 4 | 2.5 |
| Sample L | 74 | 54 | 45 | 31 | 5 | 3 |
| Sample L after HR | 71 | 52 | 42 | 28 | 5 | 3 |

In addition, the bitumen adhering to the sandstone was removed. The resultant solution can be characterized as a colloidal suspension.

Example 7 shows that the addition of surfactant to an oil-based mud can reduce the amount of oil remaining on drilled cuttings, and increase the speed at which liquid flows through a screen.

### EXAMPLE 7

An oil-based drilling mud was prepared by mixing together the following ingredients at the given volumes or concentrations:

215 mL of light mineral oil, 25 mL of Brine (New-100), Optimul™ at 8 L/m³, Optiplus™ at 12 L/m³, Optiwet™ at 8 L/m³, lime at 20 kg/M³, Bentone™ 150 at 16 kg/m³, 250 mL of drilled solids (water coated). In sample M, 7 mL of the DSTR surfactant PSA-336 were also added.

The materials were mixed together for one hour at high speed. The mud was then poured onto a mesh screen and allowed to pass through the screen for one hour. The cuttings were then removed from the screen and retorted.

Table VII illustrates the results of these measurements. Sample M shows a 43% reduction in oil on the drilled solids.

TABLE VII

| | Liquids under | Oil on | Water on | % oil on |
|---|---|---|---|---|
| | the screen | cuttings | cuttings | cuttings |
| Blank | 19 mL | 15.16 g | 13.4 mL | 20.4% |
| Sample M | 105 mL | 8.58 g | 15.5 mL | 11.7% |

Example 8 shows that the addition of surfactant can enhance clay materials used to create thixotrophy in an all-oil or invert-based system.

### EXAMPLE 8

Various surfactants (at a concentration of 2 L/m³) were mixed with clay, Bentone™ 150 (at a concentration of 25 kg/m³) in 300 mL of a light mineral oil. The materials were mixed together at high speed for 30 minutes. Rheology measurements were taken at room temperature.

Table VIII illustrates the results of the rheology measurements. Samples O,P,Q and R all showed significant improvement in rheology over the blank.

TABLE VIII

| | VISCOMETER RPM | | | | | | |
|---|---|---|---|---|---|---|---|
| | Surfactant | 600 | 300 | 200 | 100 | 6 | 3 |
| Blank | None | 12 | 8 | 6 | 4 | 2 | 2 |
| Sample N | S-104 | 9 | 6 | 5 | 3 | 1 | 1 |
| Sample O | S-485 | 12 | 8 | 7 | 5 | 4 | 4 |
| Sample P | S-420 | 12 | 7.5 | 6 | 4 | 3 | 3 |
| Sample Q | PSA-336 | 14 | 10 | 8 | 6 | 4 | 4 |
| Sample R | D-604 | 15 | 11 | 9 | 7 | 6 | 6 |

The above-described embodiments of the present invention are meant to be illustrative of preferred embodiments and are not intended to limit the scope of the present invention. Various modifications, which would be readily apparent to one skilled in the art, are intended to be within the scope of the present invention. The only limitations to the scope of the present invention are set forth in the following claims appended hereto.

The embodiments of the invention in which an exclusive property or privilege is claimed are defined as follows:

1. A fabricated fluid for use in the drilling, completion, work over or servicing of oil and gas wells or as used in the treatment or for the enhancement of production from oil and gas bearing formations, wherein said fabricated fluid includes therein a dynamic surface tension reducing (DSTR) surfactant present in a predetermined amount.

2. The fabricated fluid of claim 1 wherein said DSTR is ethoxylated non-ionic acetylenic glycol.

3. The fabricated fluid of claim 2 wherein said fabricated fluid is a drilling mud and said DSTR is present at a concentration of between 0.05% and 10% by weight.

4. The fabricated fluid of claim 3 wherein said DSTR is present at a concentration of between 0.05% and 0.5% by weight.

5. The fabricated fluid of claim 3 wherein said drilling mud is water based.

6. The fabricated fluid of claim 3 wherein said drilling mud is oil based.

7. The fabricated fluid of claim 2 wherein said fabricated fluid is a fracturing fluid and said DSTR is present at a concentration of between 0.05 and 5% by weight.

8. The fabricated fluid of claim 2 wherein said fabricated fluid is a solvent or acid based fluid used for solvent squeezes or acid washes of hydrocarbon bearing formations and wherein said DSTR is present at a concentration of 1 to 5 liters per cubic meter of solvent or acid based fluid or between 0.1% to 10% by weight.

9. The fabricated fluid of claim 2 wherein said fabricated fluid is a weighted mud used during the servicing of oil and gas wells and wherein said DSTR is present at a concentration of between 0.05% and 10% by weight.

10. The fabricated fluid of claim 9 wherein said DSTR is present at a concentration of between 0.05% and 0.5% by weight.

11. The fabricated fluid of claim 2 wherein said fabricated fluid is a fluid injected into an oil or gas bearing formation to force oil or gas remaining in said formation towards a well bore for production to the surface, wherein said DSTR is present in said injected fluid at a concentration of between 0.05% to 10% by weight.

12. A fabricated fluid for use in the drilling, completion, work over or servicing of oil and gas wells or as used in the treatment or for the enhancement of production from oil and gas bearing formations, the improvement wherein a dynamic surface tension reducing (DSTR) surfactant is added to said fabricated fluid in a predetermined amount, said DSTR being ethyoxylated non-ionic acetylenic glycol present at a concentration of between 0.05% and 10% by weight.

13. Proppant particles for use in the fracturing of oil and gas bearing formations penetrated by a well bore, the improvement wherein dynamic surface tension reducing (DSTR) surfactant is linked to a surface of some or all of said proppant particles.

14. In a method for the separation of cuttings produced during the drilling of a well bore from fluids used to transport said cuttings from the bottom of said well bore to the surface, the improvement wherein said fluid is treated by the addition of a predetermined amount of dynamic surface tensioning reducing (DSTR) surfactant to reduce adhesion between said cuttings and said fluid to facilitate the separation therebetween.

15. In the method of claim 14, wherein said DSTR is present in said fluid at a concentration of between 0.05% and 10% by weight.

16. In the method of claim 15 wherein said DSTR is ethoxylated non-ionic acetylenic glycol.

17. A method of admixing a fabricated fluid, for use in the drilling, completion, work over or surfacing of an oil or gas well or as used in the treatment or for the enhancement of production from an oil or gas bearing formation, together with at least one chemical additive, comprising the steps of:
adding said at least one chemical additive to said fabricated fluid;
adding a predetermined amount of a dynamic surface tension reducing (DSTR) surfactant to said fabricated fluid; and
admixing said fabricated fluid, said at least one chemical additive and said DSTR to prepare said fabricated fluid for use.

18. The method of claim 17 wherein said DSTR is ethoxylated non-ionic acetylenic glycol.

19. The method of claim 18 wherein said DSTR is added at a concentration of between 0.05% and 10% by weight.

20. The method of claim 19 wherein said DSTR is added at a concentration of between 0.05% and 0.5% by weight.

21. The method of claim 19 wherein said drilling fluid is a water or oil based drilling mud.

22. The method of claim 19 wherein said fabricated fluid is a fracturing fluid.

23. The method of claim 19 wherein said fabricated fluid is a solvent or acid based fluid used for solvent squeezes or acid washes of hydrocarbon bearing formations.

24. The method of claim 19 wherein said fabricated fluid is a weighted mud used during the servicing of oil and gas wells.

25. A method of fracturing an underground hydrocarbon bearing formation penetrated by a well bore, comprising the steps of:
injecting a stream of fluid into said formation at a pressure selected to cause the forming of at least one fracture in said formation;
introducing proppants into said stream of fluid for injection of said proppants into said at least one fracture; and
combining at least some of said proppants with dynamic surface tension reducing (DSTR) surfactant prior to injecting said proppants into said formation, whereby said DSTR surfactant is available to reduce surface tension between said proppants and fluids in contact with said proppants in said fracture.

26. The method of claim 25 wherein said DSTR is ethoxylated non-ionic acetylenic glycol.

27. The method of claim 26 including the additional steps of dissolving said DSTR in a solvent to produce a solution, contacting said solution with some or all of said proppants, and then evaporating said solvent to leave said DSTR combined with said some or all of said proppants.

28. The method of claim 27 wherein said DSTR is dissolved in said solvent at a concentration of between 1 to 10% by weight.

29. The method of claim 28 wherein said solvent is acetone.

30. A method of propping open a hydraulically fractured underground oil or gas bearing formation penetrated by a well bore, comprising the steps of:
introducing proppant particles into a stream of pressurized fracturing fluid, some or all of said proppant particles having dynamic surface tension reducing (DSTR) surfactant contacted to a surface thereof; and
pumping the mixture of said fracturing fluid and said proppant particles down said well bore into said formation to deposit said proppant particles in said hydraulically fractured underground formation.

31. The method of claim 30 wherein said DSTR is ethoxylated non-ionic acetylenic glycol.
